(19) United States
(12) Patent Application Publication
(10) Pub. No.: US 2006/0206487 A1
(43) Pub. Date: Sep. 14, 2006

(54) Method for restricting use of file, information processing apparatus and program product therefor

(75) Inventors: Hideki Harada, (US); Yukinobu Moriya, (US); Takeshi Omori, (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/366,292

(22) Filed: Mar. 2, 2006

(30) Foreign Application Priority Data
Mar. 8, 2005 (JP) 2005-063438

(51) Int. Cl. G06F 17/30

(52) U.S. Cl. 707/9

(57) ABSTRACT

A method for restricting a user's use of a file recorded on a client according to predetermined conditions, even if the use of the file has been authenticated previously in accordance with a policy, is provided. A method in accordance with an embodiment of the invention includes: a determination step of determining based on a policy recorded on the server whether a user of the client has a right to use the file; a recording step of changing a recording location of the file to a new recording location hidden from the user of the client and recording the file in the new recording location, in response to the determination that the user of the client has the right to use the file; and a deleting step of deleting the file from the new recording location in response to a disconnection of the client from the network.

### FIELD OF THE INVENTION

The present invention relates to a method for restricting the use of a file and, in particular, to a method, an information processing apparatus, and a program product that restrict the use of a file recorded on a client computer connected to a communication network.

### BACKGROUND OF THE INVENTION

There has been a growing interest in protection of personal information in recent years. The problem is how to protect personal information recorded on a computer in an information processing system operated at an organization such as a company in order to prevent a user using the information processing system from illegally using the personal information.

A method, such as that disclosed in Published Unexamined Patent Application No. 2004-280227, is known in which a policy that specifies each user's right to use a file is stored in an information processing system and a user is permitted to access the file if the user is successfully authenticated in accordance with the policy.

However, the method disclosed in Published Unexamined Patent Application No. 2004-280227 does not necessarily adequately protect personal information. A user authenticated in accordance with the policy can copy the file to his or her client computer to take the file out of the company.

In a company, there may be a case where a certain employee is to be allowed to access and alter some files that contain personal information and are necessary for the employee to perform work but he or she is to be prohibited from taking them out of the company. For example, an employee may take company data recorded on a notebook computer to his or her home. In such a case, personal information contained in the file held by the company can be reused outside the company. Therefore, such a method as the one described in Published Unexamined Patent Application No. 2004-280227 in which the use of file is restricted only by server authentication based on a policy provides only limited protection of personal information.

### SUMMARY OF THE INVENTION

An object of the present invention is to provide a method for restricting a user's use of a file recorded on a client according to predetermined conditions even if the file has been authenticated previously in accordance with a policy.

According to a first embodiment of the present invention, there is provided a method for restricting use of a file to be used on a client connected to a server through a network, that includes a determination step of determining based on a policy recorded on the server whether a user of the client has a right to use the file; a recording step of, in response to the determination that the user of the client has the right to use the file, changing a recording location of the file to a new recording location hidden from the user of the client and recording the file in the new recording location, and a deleting step of deleting the file from the new recording location in response to a disconnection of the client from the network. An information processing apparatus performing the same functions and a program product for causing a computer to perform the above-described method are also provided.

According to a second embodiment, there is provided a method for restricting use of a file to be used on a client connected to a server through a network, that includes a determination step of determining based on a policy recorded on the server whether a user of the client has a right to use the file; a recording step of, in response to the determination that the user of the client has the right to use the file; referring to a time limit for use of the file; changing a recording location of the file to a new recording location hidden from the user of the client, and recording the file in the new recording location; and a deleting step of deleting the file recorded in the new recording location, in response to an elapse of the time limit for use of the file. An information processing apparatus performing the same functions and a program product for causing a computer to perform the above-described method are also provided.

According to a third embodiment of the present invention, there is provided a method for restricting use of a file wherein the file is recorded in a recording location within the server, which is hidden from the user of the client, at the recording step, in addition to the first embodiment. An information processing apparatus performing the same functions and a program product for causing a computer to perform the above-described method are also provided.

According to a fourth embodiment of the present invention, there is provided a method for restricting use of a file wherein the recording step records the file in a recording location which is not to be accessed by the user when changing the recording location of the file, in addition to the first embodiment. An information processing apparatus performing the same functions and a program product for causing a computer to perform the above-described method are also provided.

The summary of the invention described above does not enumerate all the necessary features of the present invention, and a sub-combination of the features can constitute the invention.

According to the present invention, it is possible to provide a method for restricting use by a user of a file recorded on a client according to predetermined conditions even if the file has been authenticated.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an example of the configuration of a file control system in accordance with an embodiment of the present invention.

FIG. 2 shows an example of a client in accordance with an embodiment of the present invention.

FIG. 3 shows an example of a control server in accordance with an embodiment of the present invention.

FIG. 4 shows an example of the operation flow of the file control system in accordance with an embodiment of the present invention.

FIG. 5 shows an example of the operation flow of the file control system in accordance with another embodiment of the present invention.

FIG. 6 shows an example of the operation flow of the file control system in accordance with another embodiment of the present invention.

FIG. 7 shows an example of a log collection routine in accordance with an embodiment of the present invention.

FIG. 8 shows an example of a hardware configuration of the control server and a client in accordance with an embodiment of the present invention.

### DETAILED DESCRIPTION OF THE INVENTION

Preferred embodiments of the present invention will be described below with reference to the drawings.

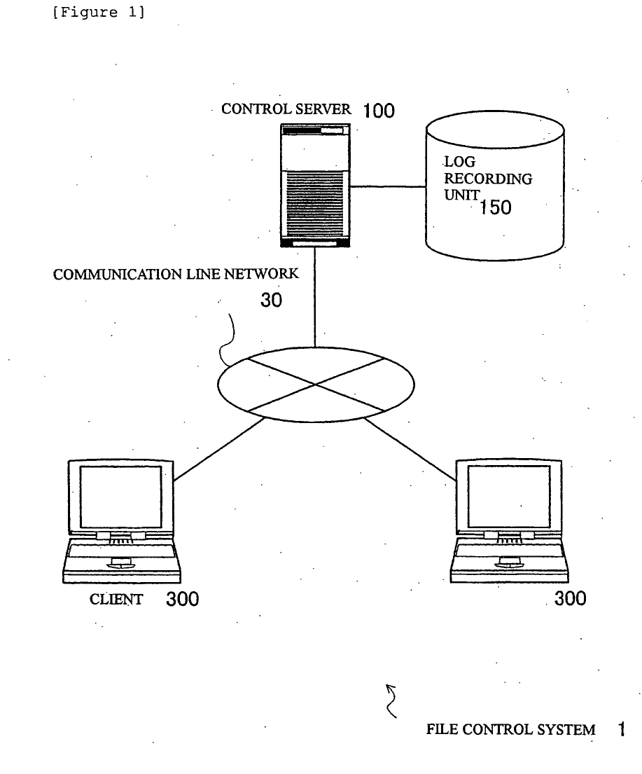

FIG. 1 shows an example of the configuration of a file control system 1. The file control system 1 is configured by clients 300 for which use of files containing personal information is restricted, a control server 100 for performing the restriction, and a communication line network 30 for connecting the clients 300 and the control server 100. The communication line network 30 may be any of a LAN, a public line, the Internet and a dedicated line or may be a network constituted by combination of these.

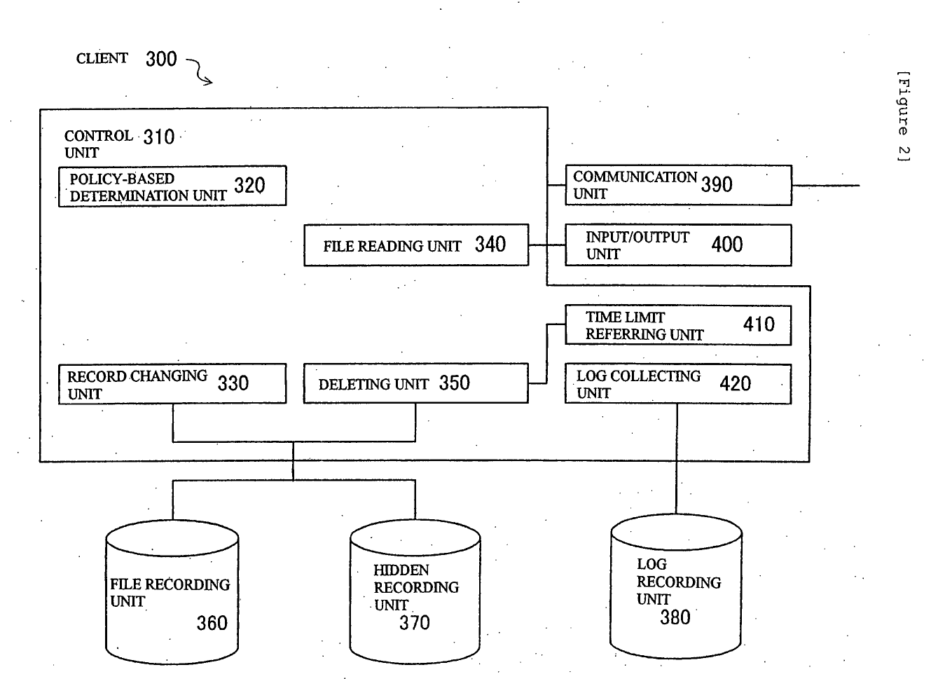

A client 300 is an information processing apparatus such as a computer for which use of a recorded file is restricted. On the client 300, a file containing personal information is edited and viewed. The client 300 may be a computer, a mobile information terminal, a mobile phone or the like. As depicted in FIG. 2, the client 300 is configured by a control unit 310 for performing control and operation of information, a communication unit 390 for connecting to the communication line network 30 to perform communication, an input/output unit 400 for accepting input from a user and outputting a file, a file recording unit 360 for recording a file, a hidden recording unit 370 which is a recording location hidden from a user, and a log recording unit 380 for recording a log.

The control unit 310 controls information on the client 300. The control unit 310 refers a user's policy to the control server 100 and is configured by a policy-based determination unit 320 for determining whether the user's policy fits a policy recorded on the control server 100, a record changing unit 330 for changing the recording location, a file reading unit 340 for reading a file, a deleting unit 350 for deleting a file according to a predetermined condition, a time limit referring unit 410 for referring to the time limit of a file, and a log collecting unit 420 for collecting logs.

The policy-based determination unit 320 confirms whether the user using the client 300 can use a file or not, with the control server 100 via the network 30, and determines whether the user can use the file. Determining that, as a result of confirming the policies recorded on the control server 100, the user's policy does not fit a policy, the policy-based determination unit 320 may display an error on the input/output unit 400 of the client 300. In this case, the policy-based determination unit 320 identifies the client 300 from the serial number, the MAC address or the name of the user who uses the client 300, and makes a determination by reading the use right of the client 300 from the policy. The policy may be a policy which is uniformly applied to multiple clients 300, such as a group policy (based on departments, titles or the like).

The record changing unit 330 changes the recording location of a file from the file recording unit 360 to the hidden recording unit 370. The record changing unit 330 changes the recording location of a file which has been determined to be used by a user on the basis of the user's policy. The record changing unit 330 may change the recording location of a file by hooking an application program interface (API) for an application activated by a user to use the file.

The file recording unit 360 is a place where a file is recorded and may be a hard disk, a memory or the like. The hidden recording unit 370 is a place where a file is recorded and is a recording location which cannot be directly accessed by the user operating the client 300. That is, the hidden recording unit 370 may be a recording location which can be recognized by an OS (operating system) or an application to carry out recording but cannot be easily accessed by a user through an ordinary program for accessing a file, which is provided for the OS or the application. The hidden recording unit 370 may be a hard disk, a memory or the like.

The file reading unit 340 reads a file in response to a request from a user. If a user accesses the file after the recording location of the file is changed by the record changing unit 330, the file reading unit 340 accesses the hidden recording unit 370 and reads the file. In this case, if the file cannot be read, the file reading unit 340 may search the file recording unit 360 to check whether or not the file is recorded there and read the file therefrom.

The deleting unit 350 deletes a file recorded on the hidden recording unit 370 according to a predetermined condition. As an example of the deletion condition, the deleting unit 350 may delete a file in response to detection by the communication unit 390 that the client 300 has cut connection with the communication line network 30. Alternatively a time limit for use may be set for the file, and the deleting unit 350 may delete the file in response to elapse of the time limit for use.

The time limit referring unit 410 records a time limit within which a file can be used, and commands the deleting unit 350 to delete the file if the time limit has elapsed. In the above-described deletion of a file recorded on the hidden recording unit 370, the time limit referring unit 410 operates in the case of performing deletion in response to elapse of the time limit for use. An example will be described in which the time limit referring unit 410 is used. The policy-based determination unit 320 checks whether a user can use the file, and it also checks the time limit within which the user can use the file. The time limit referring unit 410 records this time limit, and checks whether the current time is not past the time limit for use. If the time limit referring unit 410 determines that the time limit for use has already elapsed, it commands the deleting unit 350 to delete the file.

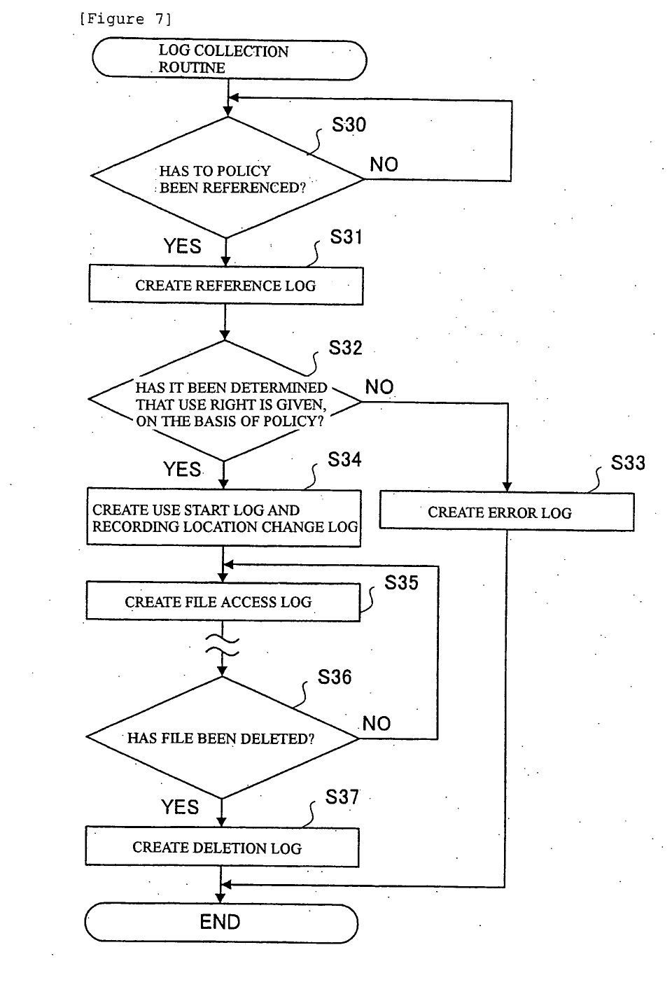

The log collecting unit 420 creates and collects logs of the client 300 and records the collected logs in the log recording unit 380. The collection of logs will be described later with reference to FIG. 7.

The communication unit 390 is connected to the communication line network 30 to perform communication. The communication unit 390 may detect that connection with the communication line network 30 has been cut and informs the deleting unit 350 of the disconnection. The communication unit 390 may also detect that connection with the communication line network 30 has been made and send the logs recorded in the log recording unit 380 to the control server 100.

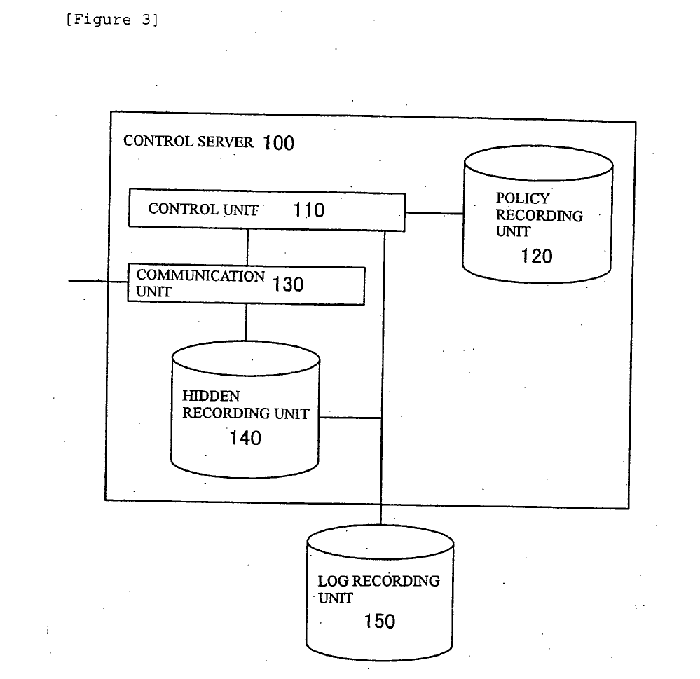

The control server 100 controls files recorded on the clients 300. As shown in FIG. 3, the control server 100 may be configured by a control unit 110 for carrying out control, a policy recording unit 120 in which policies of users using the clients 300 are recorded, a communication unit 130 for connecting to the communication line network 30 to perform communication and a hidden recording unit 140. The hidden recording unit 140 may be provided only in a third embodiment to be described later.

The control unit 110 controls information on the control server 100. The control unit 110 receives a policy confirmation request sent from a client 300, reads policies recorded on the policy recording unit 120 and responds to the confirmation request. Furthermore, the control unit 110 records the result of collection of logs performed by a client 300 in a log recording unit 150. In the case of the third embodiment to be described later, the hidden recording unit 140 is the recording location changed by the record changing unit 330. The hidden recording unit 140 and the log recording unit 150 may be hard disks, memories or the like.

In the policy recording unit 120, a time limit for use of a file may be recorded for each user in addition to a policy for each user. That is, in the case where the deleting unit 350 deletes a file in response to elapse of the time limit for use, the time limit for use may be recorded in association with a policy recorded in the policy recording unit 120.

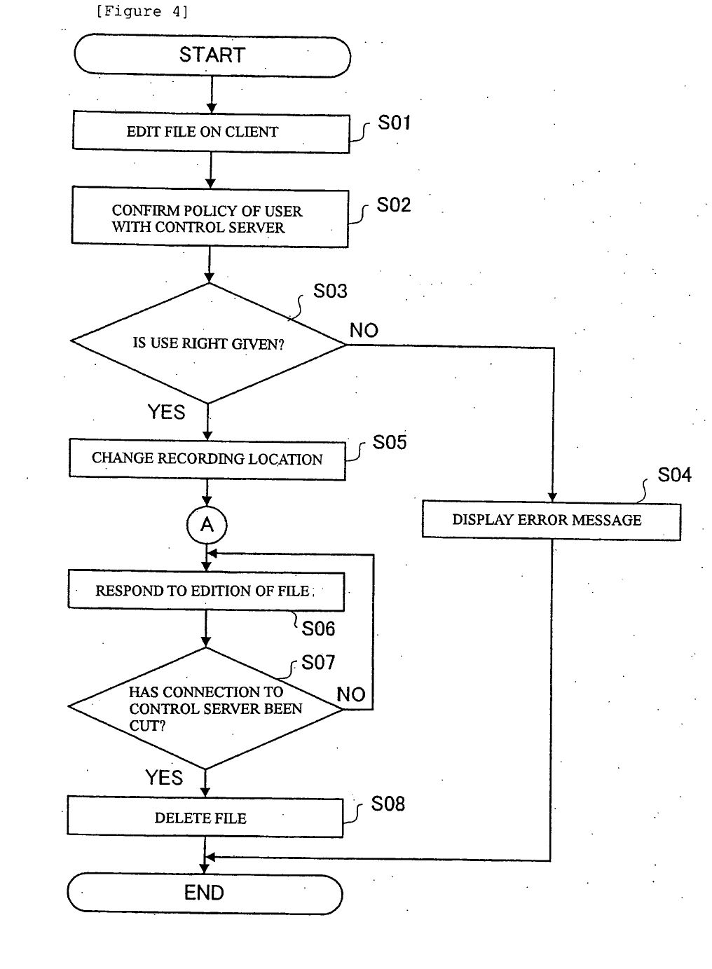

FIG. 4 shows the operation flow of a first embodiment of the file control system 1. Here, the first embodiment means the case where the hidden recording unit 370 is provided for the clients 300 and is used as a new recording location.

Editing of a file containing personal information is performed by means of an application program or the like, from the input/output unit 400 of a client 300 (step S01). In this case, the file containing personal information may be copied (downloaded) to the client 300 from a work server or the like connected to the communication line network 30, and editing may be performed for the copied file. Editing of a file may mean activating an application program for editing a file. Furthermore, editing of a file may mean activating an application program for editing a file and then storing a changed file.

Next, the policy-based determination unit 320 confirms the policy of the user with the control server 100 (step S02). If the policy-based determination unit 320 determines that “the user has a right to use the relevant file” as a result of the confirmation of the policy (step S03), then the process proceeds to step S05. If the policy-based determination unit 320 determines that “the user does not have a right to use the relevant file” as a result of the confirmation of the policy (step S03), then it displays an error message to the effect that the user does not have a right to use the file, and the process ends (step S04).

Next, the record changing unit 330 changes the recording location of the file containing personal information from the file recording unit 360 to the hidden recording unit 370 (step S05). Here, the steps S02 and S05 may be exchanged with each other. That is, it is possible that the record changing unit 330 changes the recording location of the file first (step S05), and then the policy-based determination unit 320 confirms the policy of the user with the control server 100 (step S02).

In order to have the user perform the file editing at step S01, the control unit 310 responds to the application program with respect to edition of a file (step S06). Then, if connection to the control server 100 is cut (step S07) by the client 300 being disconnected from the communication line network 30 (for example, by the user of the client 300 disconnecting the client 300 from a LAN or the like to take it outside), the deleting unit 350 deletes the file recorded in the hidden recording unit 370 (step S08). If connection to the control server 100 is not cut, then a response to the application program with respect to edition of a file is made in order to have the user edit the file (step S06).

According to the first embodiment of the present invention as described above, if a user tries to take a client 300 in which a file containing personal information is recorded to the outside, disconnection from the communication line network 30 (such as a LAN) is detected and the file recorded in a hidden location is deleted. Therefore, it is impossible for the user to take the file containing personal information to the outside to view and use the file, and consequently, leakage of the personal information can be prevented.

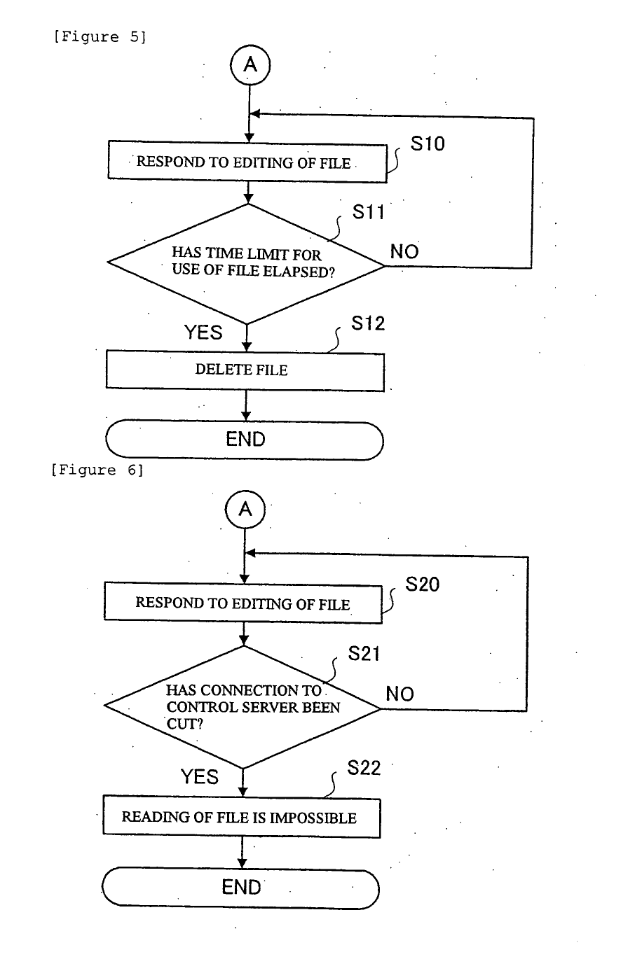

FIG. 5 shows a part of the operation flow of a second embodiment of the file control system 1. Here, the second embodiment is a mode in which the time limit for use is set for a file and the deleting unit 350 deletes the file recorded in the hidden recording unit 370 when the time limit for use has elapsed. In this case, the steps up to step S05 are the same as those in the first embodiment shown in FIG. 4, and the step S06 and the subsequent steps in the first embodiment are replaced with steps S10 and S11. That is, the time limit referring unit 410 monitors whether the time limit for use of a file has elapsed, and commands the deleting unit 350 to delete the file if the time limit for use has elapsed.

In the second embodiment, if the time limit referring unit 410 determines that the time limit for use of the file has elapsed (step S11), then the deleting unit 350 deletes the file recorded in the hidden recording unit 370.

According to the second embodiment as described above, after a user takes a client 300 in which a file containing personal information is recorded to the outside and a predetermined period elapses, the file recorded in a hidden location is deleted. For example, there may be a case where it is necessary to use a file for work outside though the file contains personal information. In such a case, if the file is deleted in response to disconnection of the client 300 from the communication line network 30, it will disturb the work. Therefore, by deleting the file from the client 300 after an appropriate period specified by a file administrator, it is possible to realize performance of the work and prevention of leakage of the personal information.

FIG. 6 shows a part of the operation flow of a third embodiment of the file control system 1. Here, the third embodiment is a mode in which the hidden recording unit 140 is provided for the control server 100 and is used as a new recording location. In this case, the steps up to step S05 are the same as those in the first embodiment shown in FIG. 4, and the step S06 and the subsequent steps in the first embodiment are replaced with steps S20 and S21. However, at step S05 in this flow, the record changing unit 330 changes the recording location of a file from the file recording unit 360 to the hidden recording unit 140 within the control server 100.

In the third embodiment, if connection to the control server 100 is cut (step S21) by a client 300 being disconnected from the communication line network 30, it is impossible to edit or view the file from the client 300 because the recording location is within the control server 100 (step S22). The control unit 110 of the control server 100 may delete the file recorded in the hidden recording unit 370.

Next, a log collection routine will be described with reference to FIG. 7. The log collecting unit 420 collects logs about a file containing personal information and records them in the log recording unit 380. The log collecting unit 420 sends the logs recorded in the log recording unit 380 to the control server 100 via the communication unit 390 as appropriate. The sent logs are recorded in the log recording unit 150 of the control server 100.

In the log collection routine, the log collecting unit 420 determines first whether the policy-based determination unit 320 has accessed the control server 100 and referred to policies (step S30). If it is determined that policy determination has been made, then a log (a reference log) indicating that the policies have been referred to is created (step S31). The reference log includes the time and date of the reference, the name of the user who referred, the accessed file name and the kind of the policy, and may include information about the time limit for use if it is set for the file. The reference log is recorded in the log recording unit 150 of the control server 100.

If the policy-based determination unit 320 determines that a client 300 which has accessed has a use right on the basis of its policy (step S32), a log about the determination, a use start log indicating that use of the file has started, and a recording location change log indicating that the recording location of the accessed file has been changed may be included (step S34). Information about the location of the hidden recording unit 370 may be included in the use start log when the recording location is changed. On the other hand, if the policy-based determination unit 320 determines that the client 300 which has accessed does not have a use right on the basis of its policy (step S32), it creates an error log indicating that the client 300 does not have the right to use the file, and the process ends (step S33).

After use of the file starts, a log about edition of the file (change, copy, deletion, rename and the like) is created as a file access log (step S35). After that, if the client 300 is disconnected from the communication line network 30 and communication with the control server 100 becomes impossible or if the time limit for use of the file has elapsed, the file is deleted by the deleting unit 350. In response to this, a deletion log containing the date and time of the deletion and the file name is created (step S37).

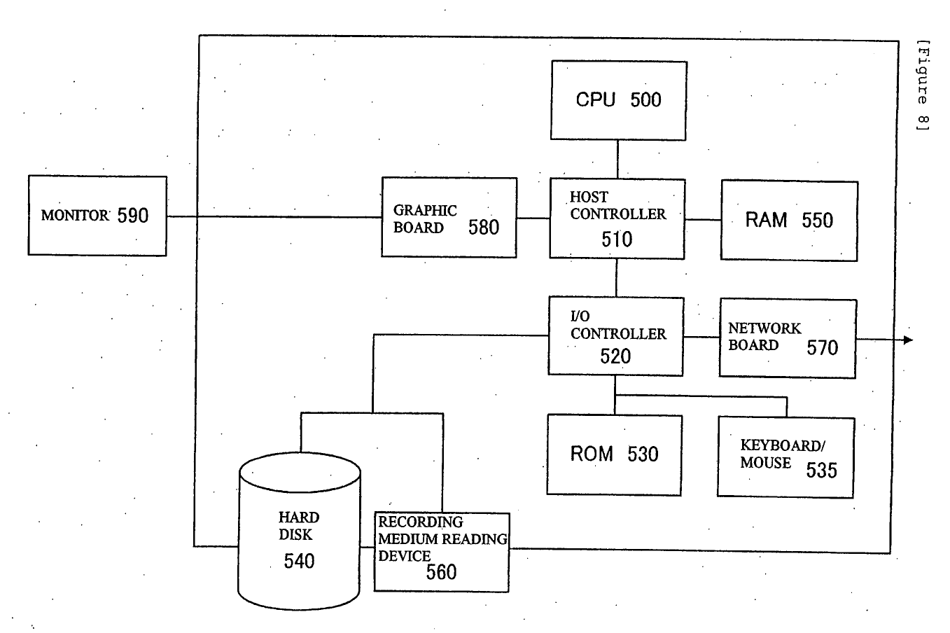

FIG. 8 shows an example of the hardware configuration of the control server 100 and a client 300. A CPU 500 reads a program for performing a function of restricting use of a file from a hard disk 540 or a recording medium reading device 560 via a host controller 510 and an I/O controller 520, stores the read program in a RAM 550 and executes the program. By executing each of steps constituting the program, the CPU 500 of the client 300 may function as the policy-based determination unit 320, the record changing unit 330, the file reading unit 340, the deleting unit 350, the time limit referring unit 410 and the log collecting unit 420. Data stored in the hard disk 540 or the recording medium reading device 560 may be read when this program is executed. The CPU 500 displays the result of determination or the result or operation on a monitor 590 via the host controller 510. The CPU 500 acquires data from the control server 100 or the client 300 connected to the communication line network 30 via a network board 570 and the I/O controller 520.

A method for restricting use of a file, which implements these embodiments, can be realized by a program to be executed by a computer or a server. As a storage medium for the program, there are included an optical storage medium, a tape medium and a semiconductor memory and the like. It is also possible to use a storage device such as a hard disk or a RAM provided for a server system connected to a dedicated communication network or the Internet as a storage medium to provide the program via the network.

The embodiments of the present invention have been described. However, only specific examples have been illustrated, and the present invention is not especially limited to the embodiments. Only the most preferred advantages provided the present invention have been enumerated in the embodiments of the present invention, and advantages of the present invention are not limited to those described in the embodiments of the present invention.

### DESCRIPTION OF REFERENCE NUMBERS

1 File control system
30 Communication line network
100 Control server
110 Control unit
120 Policy recording unit
130 Communication unit
140 Hidden recording unit
150 Log recording unit
300 Client
310 Control unit
320 Policy-based determination unit
330 Record changing unit
340 File reading unit
350 Deleting unit
360 File recording unit
370 Hidden recording unit
380 Log recording unit
390 Communication unit
400 Input/output unit
410 Time limit referring unit
420 Log collecting unit
500 CPU
510 Host controller
520 I/O controller
530 ROM
535 Keyboard/mouse
540 Hard disk
550 RAM
560 Recording medium reading device
570 Network board
580 Graphic board
590 Monitor

1. A method for restricting use of a file to be used on a client connected to a server through a network, comprising:
a determination step of determining based on a policy recorded on the server whether a user of the client has a right to use the file;
a recording step of, in response to the determination that the user of the client has the right to use the file, changing a recording location of the file to a new recording location hidden from the user of the client and recording the file in the new recording location; and
a deleting step of deleting the file from the new recording location in response to a disconnection of the client from the network.

2. The method for restricting use of a file according to claim 1, wherein the recording step records the file in a recording location which may not be accessed by the user when changing the recording location of the file.

3. The method for restricting use of a file according to claim 1, further comprising a step of, in response to the recording location of the file being changed at the recording step, sending a log about the change of the recording location to the server.

4. The method for restricting use of a file according to claim 1, further comprising a step of, in response to access to the file after the change of the recording location of the file at the recording step, responding to the access to the file by accessing the new recording location of the file.

5. The method for restricting use of a file according to claim 1, wherein the policy recorded on the server at the determination step is a group policy.

6. The method for restricting use of a file according to claim 1, further comprising a step of the client returning a predetermined message to the user in response to determination at the determination step that the user does not have the right to use the file.

7. The method for restricting use of a file according to claim 1, wherein
the file is recorded in a recording location within the server, which is hidden from the user of the client, at the recording step; and
the server deletes the file recorded in the new recording location in response to the disconnection from the network.

8. A method for restricting use of a file to be used on a client connected to a server through a network, comprising:
a determination step of determining based on a policy recorded on the server whether a user of the client has a right to use the file;
a recording step of, in response to the determination that the user of the client has the right to use the file, referring to a time limit for use of the file, changing a recording location of the file to a new recording location hidden from the user of the client, and recording the file in the new recording location; and
a deleting step of deleting the file recorded in the new recording location, in response to an elapse of the time limit for use of the file.

9. The method for restricting use of a file according to claim 8, comprising a step of recording information about the file on the server as a log in response to a reconnection to the network.

10. An information processing apparatus which is connected to a server through a network and restricts use of a recorded file, comprising:
a policy-based determination unit for determining based on a policy recorded on the server whether a user of the information processing apparatus has a right to use the file;
a record changing unit for changing a recording location of the file to a new recording location hidden from the user of the information processing apparatus and recording the file in the new recording location, in response to the determination that the user of the information processing apparatus has the right to use the file; and
a deleting unit for deleting the file recorded in the new recording location, in response to a disconnection of the information processing apparatus from the network.

11. The information processing apparatus according to claim 10, wherein the record changing unit records the file in a recording location which may not be accessed by the user when changing the recording location of the file.

12. The information processing apparatus according to claim 10, further comprising a communication unit for, in response to the change of the recording location of the file, sending a log about the change of the recording location to the server.

13. The information processing apparatus according to claim 10, further comprising a file reading unit for, in response to access to the file after the change of the recording location of the file, responding a an access to the file by accessing the changed recording location of the file.

14. The information processing apparatus according to claim 10, wherein the policy recorded on the server, which is to be determined by the policy-based determination unit, is a group policy.

15. The information processing apparatus according to claim 10, wherein the information processing apparatus returns a predetermined message to the user in response to determination by the policy-based determination unit that the user does not have the right to use the file.

16. An information processing apparatus which is connected to a server through a network and restricts use of a recorded file, comprising:
a policy-based determination unit for determining based on a policy recorded on the server whether a user of the information processing apparatus has a right to use the file;
a record changing unit for referring to a time limit for use of the file, changing a recording location of the file to a new recording location hidden from the user of the information processing apparatus, and recording the file in the new recording location, in response to the determination that the user of the information processing apparatus has the right to use the file; and
a deleting unit for deleting the file recorded in the new recording location, in response to an elapse of the time limit for use of the file.

17. A program product for restricting use of a file to be used on a client connected to a server through a network, said program product providing:
a determining function of determining based on a policy recorded on the server whether a user of the client has a right to use the file;
a recording function of, in response to the determination that the user of the client has the right to use the file, changing a recording location of the file to a new recording location hidden from the user of the client and recording the file in the new recording location; and
a deleting function of deleting the file from the new recording location in response to a disconnection of the client from the network.

18. A program product for restricting use of a file to be used on a client connected to a server through a network, said program product providing:
a determining function of determining based on a policy recorded on the server whether a user of the client has a right to use the file;
a recording function of, in response to the determination that the user of the client has the right to use the file, referring to a time limit for use of the file, changing a recording location of the file to a new recording location hidden from the user of the client, and recording the file in the new recording location; and
a deleting function of deleting the file recorded in the new recording location, in response to an elapse of the time limit for use of the file.
